(19) United States
(12) Patent Application Publication
(10) Pub. No.: US 2013/0202760 A1
(43) Pub. Date: Aug. 8, 2013

(54) AUTOMATED OATMEAL STEAMER

(71) Applicants: David A. Holcomb, Seattle, WA (US); Stephen Davenport, Seattle, WA (US); Adam A. Jossem, Seattle, WA (US)

(72) Inventors: David A. Holcomb, Seattle, WA (US); Stephen Davenport, Seattle, WA (US); Adam A. Jossem, Seattle, WA (US)

(73) Assignee: CHEF'N CORPORATION, Seattle, WA (US)

(21) Appl. No.: 13/598,385

(22) Filed: Aug. 29, 2012

Related U.S. Application Data
(60) Provisional application No. 61/528,391, filed on Aug. 29, 2011.

(51) Int. Cl. A47J 27/06

(52) U.S. Cl. CPC A47J 27/06
USPC 426/510; 99/426

(57) ABSTRACT

A device, system and method for cooking hot cereal are disclosed. Embodiments of the device and system incorporate a steam chamber adapted to hold a bowl of dry cereal and to retain steam in the presence of the bowl; a reservoir for holding water; a filling line and faucet coupled to the reservoir and configured to route water from the reservoir, out the faucet and into the bowl of dry cereal; and a steam generator coupled to the reservoir for generating steam and routing the steam into the steam chamber to cook the cereal. Embodiments of the method incorporate a timer and controls to automatically fill the cereal bowl and cook the cereal at a pre-selected time.

### CROSS REFERENCE TO RELATED APPLICATION

This application claims the benefit under 35 U.S.C. §119(e) of U.S. Provisional Patent Application No. 61/528,391 filed Aug. 29, 2011, which is incorporated herein by reference in its entirety.

### BACKGROUND OF THE INVENTION

1. Field of the Invention

The present disclosure is related to devices, systems and methods for cooking hot cereal, and more particularly, to an automated device for steaming breakfast cereal such as oatmeal.

2. Description of the Related Art

Oatmeal typically is either boiled or, with instant oatmeal, heated and re-hydrated by stirring it in hot water. Many people do not enjoy instant oatmeal; and many others often do not have the time to properly cook oatmeal from scratch, if at all.

### BRIEF SUMMARY OF THE INVENTION

The present disclosure is directed toward a device that allows an individual to eat traditional (i.e., not instant) oatmeal—or other types of hot breakfast cereal—without having to cook it in the traditional manner. In embodiments, the present disclosure is directed toward a device that allows an individual to merely pour dry, uncooked cereal into a bowl, place the bowl in the device, fill the device with water, set the device's timer for the time when the user wants to enjoy the cooked cereal, then return at the designated time to enjoy perfectly and traditionally cooked (i.e., not instant) hot cereal.

One embodiment of the device incorporates a water reservoir, a steam chamber adapted to receive a typical cereal bowl, a faucet on or in the steam chamber positioned, oriented and controlled for filling the bowl with the proper amount of liquid water, and a steamer controlled for filling the steam chamber with steam for the proper amount of time to cook the cereal. Embodiments of the device can be used immediately or automated for use at a later time. Embodiments of the device can be configured to cook different types of cereal (e.g., grits) and even different types of oatmeal (e.g. steel cut or rolled oats).

### BRIEF DESCRIPTION OF THE SEVERAL VIEWS OF THE DRAWINGS

For a better understanding of the invention as well as other objects and further features thereof, reference is made to the following description, which is to be read in conjunction with the accompanying drawing wherein:

FIG. 1 is a perspective view of a device for cooking hot cereal according to an embodiment of the present invention;

FIG. 2 is a perspective view of the device of FIG. 1, with a steamer cover and water bottle cap removed;

FIG. 3 is a perspective view of the device of FIG. 2, with a bowl and water bottle also removed;

FIG. 4 is a perspective view of the device of FIG. 3, with an upper housing also removed; and

FIG. 5 is a perspective view of the device of FIG. 4, with a steam generator and water filter also removed.

FIG. 6 is a bottom plan view of the device of FIG. 1 with a bottom cover removed.

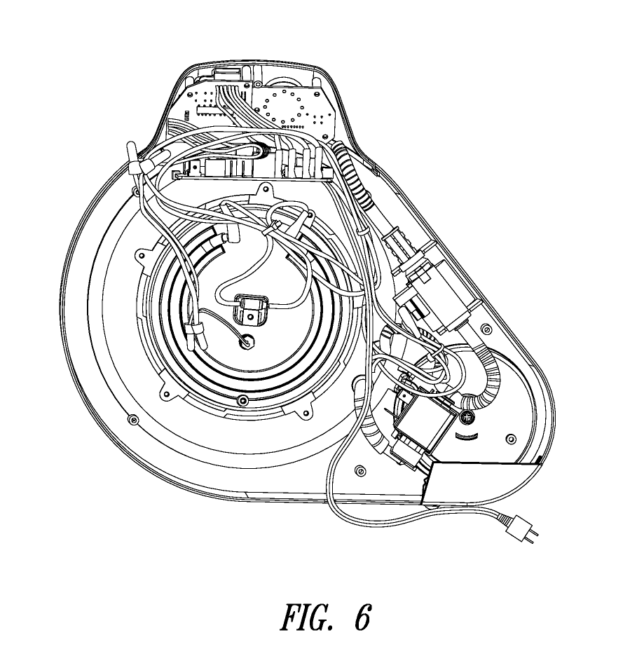

### DETAILED DESCRIPTION OF THE INVENTION

The present disclosure is directed toward devices, systems and methods for cooking hot breakfast cereal. This specification and the associated drawings illustrate and describe several specific details and features of one such device, system and method. The inventors appreciate that one of ordinary skill in the art, having reviewed this disclosure in its entirety, will appreciate that changes could be made to the details provided or illustrated in this disclosure and/or that some details could be eliminated from particular embodiments, without causing the resultant embodiment to deviate from the present invention.

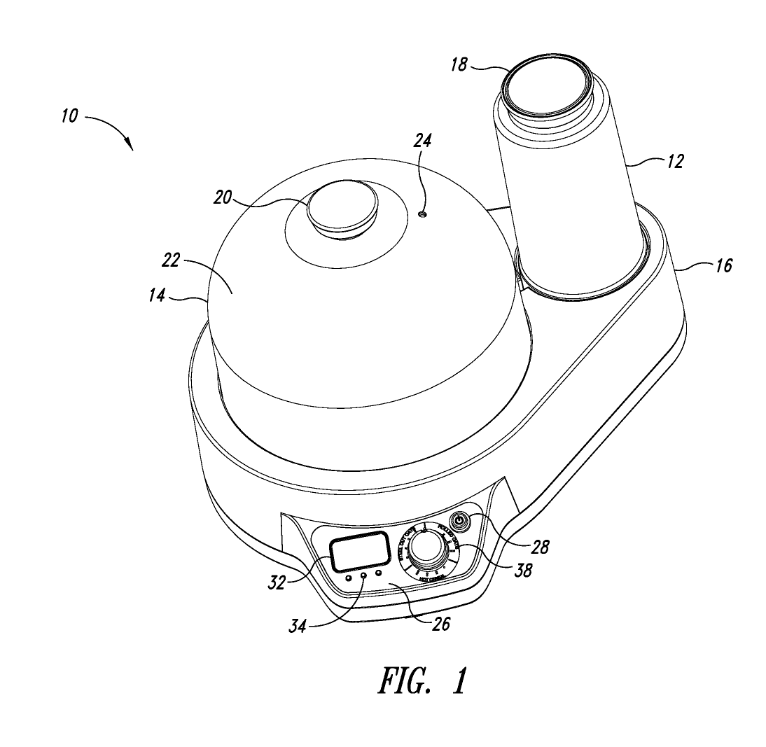

FIG. 1 illustrates one particular embodiment of a device 10 for cooking breakfast cereal, such as cream of wheat, grits or oatmeal. Throughout this disclosure various terms may be used to identify or describe the cereal being cooked. The invention is intended to be applicable to all types of hot cereal, despite using a narrower term in any particular instance.

The illustrated device 10 generally incorporates a water reservoir 12, a steam chamber 14 and a base 16. The water reservoir 12 and the steam chamber 14 reside on the base 16 and, as discussed herein, are operably connected to each other and to the components housed in the base.

The water reservoir 12 is adapted to hold sufficient water to make and steam at least one bowl of hot cereal. The water reservoir 12 can be adapted for a single-use device or a multi-use device, and can be adapted with indicia, a viewing port, or other features to facilitate use by an operator. A removable cap 18 on the water reservoir 12 allows the water reservoir to be refilled between uses of the device 10.

The water reservoir 12 is connected to the steam chamber 14 via components in the body 16, as disclosed and explained below. During operation, as also disclosed and described below, water from the water reservoir 12 is heated to steam to cook the hot cereal or other product inside the steam chamber 14. The water from the water reservoir 12 also can be injected into the cereal itself to hydrate the cereal immediately before being cooked, avoiding the need for the user to pour water in the cereal. This feature can allow the user to put dry cereal in the device long before the device cooks the cereal, such as the night before eating it for breakfast. As a result, the device can cook hot cereal while the user is sleeping, without the cereal becoming soggy or otherwise being adversely impacted by the long term presence of water.

The illustrated steam chamber 14 has a knob or other form of handle 20 that can be used when removing or replacing a lid 22 of the steam chamber 14 on or off the base, such as when inserting a bowl of cereal into or removing it from the device 10. The lid 22 in the illustrated embodiment has a vent 24 therein to allow steam to escape from the steam chamber 14, as necessary or desirable.

A control panel 26 on the device 10 can incorporate a power switch 28, a setting selector dial 30 and a display 32. The illustrated power switch 28 is a button, but could be any form of switch or could be incorporated into the selector dial 30 or other feature. The selector dial 30 in the illustrated embodiment is adapted to allow the user to select between steel cut oats, rolled oats and hot cereal. As described in more detail below, the various types of hot cereal require different cooking times and, as such, the device can be adapted to cook any specific type of cereal, or could be designed with a timer or other feature that allows the user to specify the exact amount of time a product will be cooked instead of the type of product.

One or more inputs 34 are shown on the control panel 26. The inputs 34 can be used to control the operation of the device 10, set a clock, alarm or other feature. For example, the display 26 can provide the user with the current time, and the inputs 34 can be used to change the time or set the device to start at a desired time in the future. An individual of ordinary skill in the art, having reviewed this entire disclosure, will appreciate that various modifications can be made to these particular operations and that additional operations can be configured into the device 10.

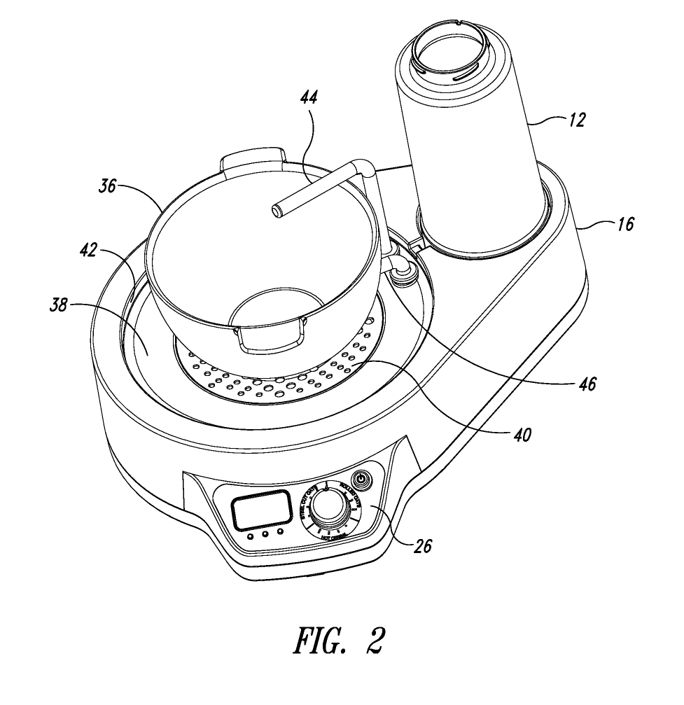

FIG. 2 is a perspective view of the device 10 in which the lid 22 of the steam chamber 14 and the cap 18 from the water reservoir 12 have been removed. A bowl 36 rests on a bottom 38 of the steam chamber 14. A screen 40 is positioned on the bottom 38 of the steam chamber 14 to allow steam to enter the steam chamber from below. In the illustrated embodiment the bowl 36 rests on the screen 40. The screen 40 could instead be positioned away from the center of the bottom 38, and could be replaced by slats, a mesh or any other structure that allows steam to pass through the bottom. A wall 42 extends around a perimeter of the bottom 38. The lid 22 of the steam chamber 14 and the wall 42 interact when the lid is positioned on the base 16 to minimize or eliminate steam from escaping from the steam chamber unintentionally. Instead, the vent 24 can be configured to allow steam to escape the steam chamber 14 under pre-selected conditions. The wall 42 and/or the lid 22 can be adapted to seal the steam chamber 14, such as by using a polymer or other sealing material or structure.

In the illustrated embodiment of the device 10, an upper faucet 44 and a lower faucet 46 project upward from the base 16 and terminate within the steam chamber 14. In the illustrated embodiment, the upper and lower faucets 44, 46 exit the base 16 from a point within the steam chamber 14. The upper faucet 44 terminates at a location above the bowl 36 when the bowl is resting on the bottom 38 of the steam chamber 14. During selected uses of the device 10 the upper faucet 44 can be used to inject water into the bowl 36 before the cereal in the bowl is heated. In other instances the bowl can be pre-filled by the operator, such as at a sink or using a separate container.

The lower faucet 46 in the illustrated embodiment is positioned above the screen 40, and is adapted to inject water into a steam generator (described below) prior to the device 10 cooking the cereal. The lower faucet 46 could instead dispense the water elsewhere on the bottom 38 of the steam chamber 14 and the bottom could be shaped to route the water into the steam generator, or the water could be injected into the steam generator inside the base 16. In still other embodiments, the operator could pour water into the steam generator. An individual of ordinary skill in the art, having reviewed this entire disclosure, will immediately appreciate these and other various ways the water can be directed to the steam generator without deviating from the spirit of the invention.

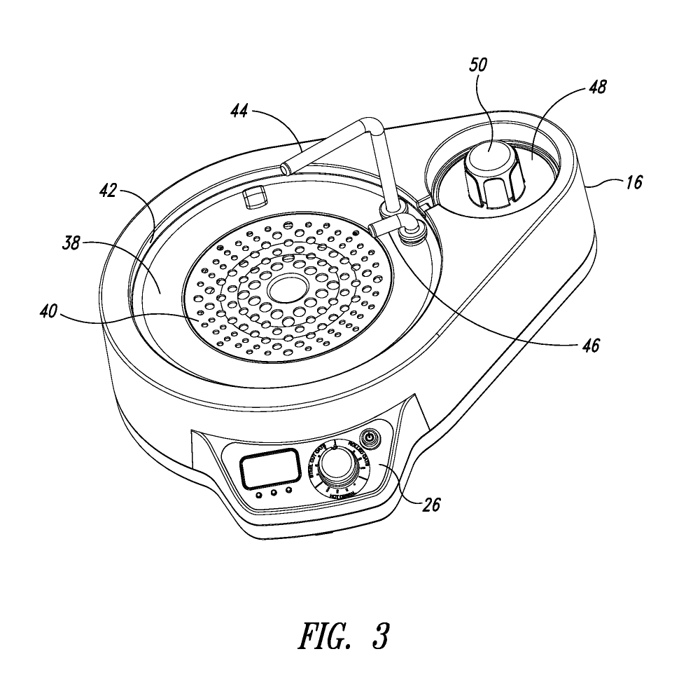

FIG. 3 is a perspective view of the device 10 shown in FIG. 2, with the water reservoir 12 and the bowl 36 also removed. A recess 48 in the base 16 is sized and shaped to receive a lower portion of the water reservoir 12. In the illustrated embodiment, both the water reservoir 12 and the recess 48 have circular cross-sections; however the size and shape of the two can be changed as necessary or desirable for particular embodiments of the device 10. A filter 50 positioned within the recess 48 of the illustrated device 10 can remove particulates and other undesirable contents from water held in the water reservoir 12 before the water is introduced into the system.

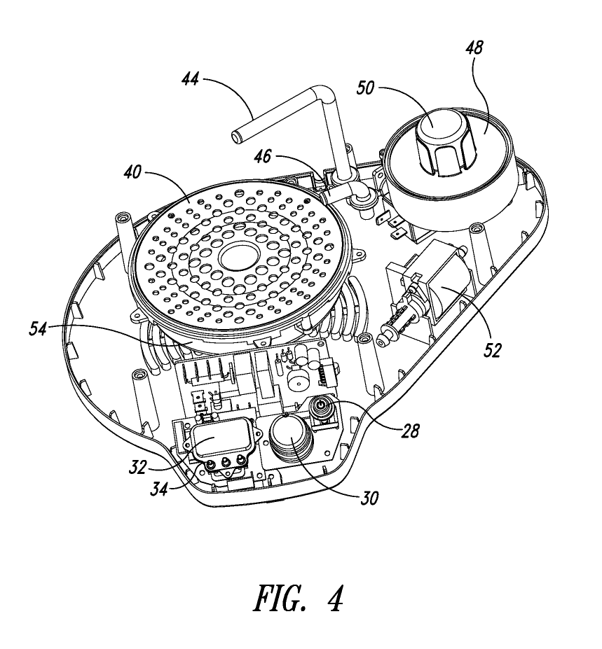

FIG. 4 is a perspective view of the device 10 shown in FIG. 3, with an upper housing portion of the base 16 removed to show some of the components housed within the base. A pump 52 can be positioned near the water reservoir 12, and can be positioned with a pump inlet 62 lower than a reservoir outlet 60 on the water reservoir so that water leaving the reservoir flows under the force of gravity to the pump. In the illustrated embodiment, reservoir outlet 60 is depicted as a spring valve, which mates with an outlet in the base of the water reservoir. The pump 52 can then pressurize the water for distribution to the steam chamber 14 and, ultimately, to the bowl 36 and/or a pan 54. The pan 54 is located below the screen 40 so that steam generated in the pan passes through the screen and fills the space in the steam chamber 14 between the bottom 38 and the lid 22.

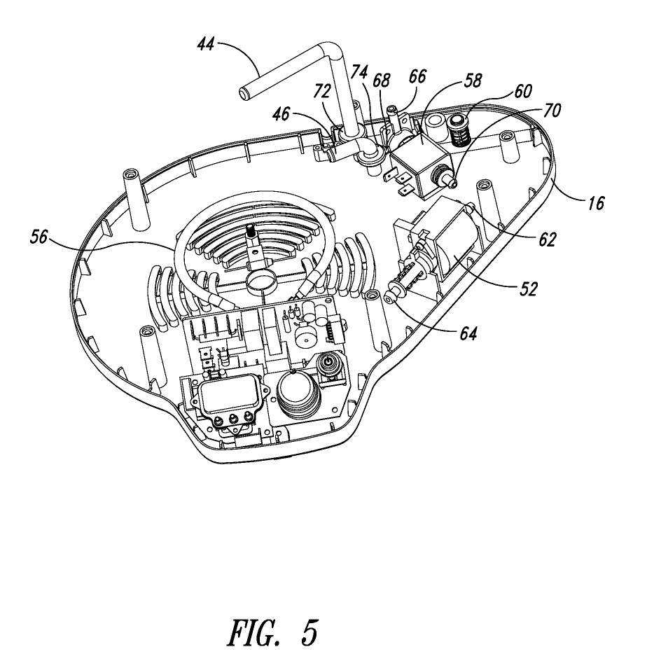

FIG. 5 is a perspective view of the device 10 shown in FIG. 3, with the screen 40 and pan 54 removed to show more components within the base 16. A heating element 56 under the pan 54 is controllable by one or more of the components on the control panel 26 to heat water in the pan to make steam.

A control valve 58 downstream of a pump outlet 64 is also controllable by one or more of the components on the control panel 26 to route water to the bowl 36 via the upper faucet 44, the pan 54 via the lower faucet 46, or both. Water entering a single valve inlet 66 on the control valve 58 is controllably routed to one or both of two outlets (e.g., a first valve outlet 68 coupled to an upper faucet inlet 72, and a second valve outlet 70 coupled to a lower faucet inlet 74), depending on whether the system is filling the bowl 36 and/or preparing to cook the hot cereal. An individual of ordinary skill in the art, having reviewed this entire disclosure, will appreciate the range of heating elements, pumps, control valves and other components that can be sources and incorporated into the system without deviating from the spirit of the invention.

Among other possible components and configurations of the control panel 26 and associated circuitry, in one embodiment a filling control can be operable to start and stop the pump 52 to control the flow of water from the water reservoir 12, and a valving control can be operable to route water leaving the pump to the upper faucet 44 for filling a bowl of dry cereal and/or to the lower faucet 46 to fill the pan 56 for making steam. The filling control can be manually or automatically operated for varying amounts of time—or based on a signal from a sensor reading flow rate or volume (not shown), or using other known sensors and controls—to dispense a proper volume of water based on the size of the bowl and the type of cereal.

Similarly, a steaming control can be operable for activating the heating element 56 to generate steam and cook the bowl 36 of cereal in the steam chamber 14. The steaming control can be configured with a manual, adjustable timer (not shown) or can be controlled by a clock to start and stop the steam at proper times. The times can be set by the user or can be controlled by a computer (not shown) based on the size of the bowl, the type of cereal, the altitude, or any other factor relevant to cooking. The clock can also be configured to control the filling control and, as such, can be used to fully automate the device 10 such that an individual can place a bowl 36 of dry cereal in the steam chamber 14, fill the water reservoir 12 with water, and set the clock for a later time, such as the following morning, when the user will want to eat a hot bowl of cereal.

One possible method of using the device 10 includes the following steps:

The water reservoir 12 is filled with a sufficient amount of water and a bowl 36 containing a serving of uncooked dry cereal is positioned inside the steam chamber 14. The lid 22 is seated in the bottom 38 of the steam chamber 14. The device 10 is ready to begin cooking Depending on the desire of the user, the device 10 can be started immediately or can be set to begin cooking at a later time. Because the dry cereal has no water in it, the cereal need not be cooked immediately.

When the system is ready to begin cooking the cereal, water from the water reservoir 12 is pumped by the pump 52 through the control valve 58 and out the upper faucet 44. Water is pumped into the bowl 36 until the filling control turns off the pump 52 based on user input, input from a computer, or a signal from the clock. Once the bowl 36 is full (i.e., it has enough water to cook the amount of cereal in it), the pump 52 is shut off and the water stops flowing.

At this point, water from the pump 52 is routed by the control valve 58 to the lower faucet 46 and into the pan 54. The steaming control actuates the heating element 56 to create steam, which enters the steam chamber 14 through the screen 40. The steaming control continues to actuate the heating element 56 until the clock or operator sends a signal to the steaming control to turn off the heating element 56. At this point, the steam chamber 14 is still filled with steam and the cereal in the bowl 36 is cooking.

The bowl 36 of hot cereal cooks by heat from the steam. In some embodiments, the device 10 can be configured to signal to the user that the cereal is cooked as soon as the heating element 56 is turned off. In other embodiments, the device 10 can allow the cereal in the bowl 36 to continue cooking after the heating element 56 turns off, signaling the user only after the residual steam has finished cooking the cereal. An individual of ordinary skill in the art, having reviewed this entire disclosure, will appreciate that changes can be made to these steps, the sequence, and the structure used in one or more of the steps, all without deviating from the spirit of the invention.

While the invention has been described with a reference to its preferred embodiment, it will be understood by those skilled in the art that various changes may be made and equivalents may be substituted for elements thereof without departing from the true spirit and scope of the invention. In addition, modifications may be made to adapt a particular situation or material to the teachings of the invention without departing from its essential teachings.

What is claimed is:

1. A device for cooking cereal, the device comprising:
a steam chamber sized and shaped to hold a cereal bowl and adapted to retain steam therein;
a water reservoir adapted to hold at least enough water to fill the cereal bowl with enough liquid water to make hot cereal and also to fill the steam chamber with steam for long enough to cook the cereal;
a faucet in fluid communication with the steam chamber and the reservoir, the faucet being positioned and oriented to direct water from the reservoir into the bowl; and
a steam generator coupled between the reservoir and the steam chamber, the steam generator adapted to create steam using water from the reservoir and routing the steam to the steam chamber for enough time to cook a bowl of hot cereal.

2. The device of claim 1 wherein the steam chamber comprises a floor, the floor having a plurality of openings therein configured to allow steam to pass therethrough.

3. The device of claim 1 wherein the steam chamber comprises a floor, the floor having a plurality of openings therein configured to allow steam to pass therethrough, and wherein the steam generator is at least partially housed in the steam chamber below the floor.

4. The device of claim 1, further comprising a pump positioned between the reservoir and the faucet.

5. The device of claim 1, further comprising a clock for controlling the amount of time that liquid water is dispensed from the faucet.

6. The device of claim 1 wherein the faucet is located within the steam chamber.

7. The device of claim 1, further comprising a clock for controlling the amount of time that the steam generator generates steam.

8. The device of claim 1 further comprising a clock for controlling the amount of time that the steam generator generates steam and the amount of time that liquid water is dispensed from the faucet.

9. The device of claim 1, further comprising a clock for starting the device at a pre-selected time.

10. A system for automatically cooking hot cereal, the system comprising:
a steam chamber sized and shaped to hold a cereal bowl and adapted to retain steam therein, the steam chamber having a lid, a wall, and a floor for supporting the cereal bowl thereon;
a water reservoir adapted to hold enough water to fill the cereal bowl with enough liquid water to make hot cereal and also to fill the steam chamber with enough steam for long enough to cook the cereal;
a faucet coupled to the steam chamber and in fluid communication with the reservoir, the faucet being positioned and oriented to direct water from the reservoir into the bowl;
a pump coupled between the reservoir and the faucet;
a steam generator coupled between the reservoir and the steam chamber, the steam generator adapted to create steam using water from the reservoir and routing the steam to the steam chamber for enough time to cook a bowl of hot cereal; and
a controller for starting and stopping the pump to dispense a desired amount of water into the cereal bowl and for starting and stopping the steam generator to cook the cereal.

11. A method for cooking hot cereal, the method comprising:
providing a chamber sized and shaped to hold a cereal bowl and adapted to retain steam therein;
providing a reservoir for retaining sufficient water to make the cereal and to create enough steam to cook the cereal;
placing a cereal bowl holding dry cereal into the steam chamber;
dispensing liquid water into the cereal bowl; and
injecting steam into the steam chamber to cook the cereal.
